(19) United States
(12) Patent Application Publication
(10) Pub. No.: US 2026/0097312 A1
(43) Pub. Date: Apr. 9, 2026

(54) LIVE VOICE SYNTHESIS WITH VOICE MIXING

(71) Applicant: Microsoft Technology Licensing, LLC, Redmond, WA (US)

(72) Inventors: Mastafa Hamza FOUFA, Seattle, WA (US); Corentin Alexandre BRAUGE, Tokyo (JP)

(21) Appl. No.: 18/907,329

(22) Filed: Oct. 4, 2024

(51) Int. Cl. A63F 13/63; A63F 13/215; A63F 13/54; G10L 13/033; G10L 13/047

(52) U.S. Cl. CPC A63F 13/63; A63F 13/215; A63F 13/54; G10L 13/033; G10L 13/047

(57) ABSTRACT

Systems, devices, methods, and machine-readable media configured to provide voice inference in a video game are provided. A video game system can include an encoder configured to generate a first encoding representative of physical characteristics of a specified entity, a similarity operator configured to determine similarity values between (i) corresponding stored encodings of multiple characters, the stored encodings representative of physical characteristics of respective characters of the multiple characters and (ii) the first encoding, identify a selected character from the multiple characters based on the similarity values, and provide an identifier of the selected character, a voice database configured to provide audio or a spectrogram of the selected character, and a video game configured to provide the audio of a player-selected character in a voice of the selected character.

### BACKGROUND

Those who play role play video games desire a more immersive experience. Role play games are typically played with users controlling respective characters that are represented by graphics. The users will often wear headsets through which they communicate with other users playing the game. The voice of the user is typically their own voice, which does not match the build of the character they are controlling. This sort of experience is not very immersive and makes it difficult for the users to suspend disbelief.

### SUMMARY

Embodiments regard systems, devices, methods, a computer-readable media for live voice synthesis using voice inference, voice mixing, or a combination thereof. The voice synthesis helps preserve privacy of users and reduce cyber bullying. The voice synthesis further helps improve the immersive quality of a role playing game by making a voice of a character better match the build of the character.

A system can include an encoder configured to generate a first encoding representative of physical characteristics of a specified entity. The system can further include a similarity operator configured to determine similarity values between (i) corresponding stored encodings of multiple characters, the stored encodings representative of physical characteristics of respective characters of the multiple characters and (ii) the first encoding. The similarity operator can be further configured to identify a selected character from the multiple characters based on the similarity values. The similarity operator can be further configured to provide an identifier of the selected character. The system can further include a voice database configured to provide audio or a spectrogram of the selected character. The system can further include video game configured to provide the audio of a player-selected character in a voice of the selected character.

The physical characteristics can represent physical attributes of respective characters in the video game. The entity can be a player of the video game. The encoder can generate the first encoding based on an image of the player.

The video game can further include a physical characteristic selection interface. The interface can be configured to present physical characteristics to the player. The interface can be configured to receive, from the player, the physical characteristics of the entity.

The system can further include a voice transform model trained to receive spectrograms of multiple, player-selected characters. The voice transform model can be configured to generate a composite spectrogram that is a mixture of the received spectrograms. The received spectrograms can include a spectrogram of the selected character. The selected character can be associated with physical characteristic most similar to the entity. The received spectrograms can include a spectrogram of audio from the player. The voice transform model can include a sequence-to-sequence model that is trained to convert the received spectrograms directly into the composite spectrogram.

A method can include generating, by an encoder model, a first encoding representative of physical characteristics of a specified entity. The method can further include determining, by a similarity operator, similarity values between corresponding stored encodings of multiple characters and the first encoding. The stored encodings can be representative of physical characteristics of respective characters of the multiple characters. The method can further include identifying, by the similarity operator, a selected character from the multiple characters based on the similarity values. The method can further include providing an identifier of the selected character, retrieving, by a voice database and based on the identifier, audio or a spectrogram of the selected character. The method can further include providing, by a video game and based on the audio or the spectrogram of the character, audio of a player-selected character in a voice of the selected character.

The entity can be a player of the video game. The method can further include receiving, by the encoder model, an image of the player. The encoder model can generate the first encoding based on the image of the player. The method can further include presenting, by a physical characteristic selection interface of the video game, physical characteristics. The method can further include receiving, from the player, the physical characteristics of the entity.

The method can further include receiving, by a voice transform model, spectrograms of multiple, player-selected characters. The method can further include generating, by the voice transform model a composite spectrogram that is a mixture of the received spectrograms.

The received spectrograms can include a spectrogram of the selected character and the selected character is associated with physical characteristic most similar to the entity. The received spectrograms can include a spectrogram of audio from the player. The voice transform model can include a sequence-to-sequence model trained to convert the received spectrograms directly into the composite spectrogram.

A machine-readable medium can include instructions that, when executed by a machine, cause the machine to perform the method.

### BRIEF DESCRIPTION OF THE DRAWINGS

FIG. 1 illustrates, by way of example, a diagram of an embodiment of a system for voice synthesis via voice mixing.

FIG. 2 illustrates, by way of example a flow diagram of an embodiment of a method for populating the voice database.

FIG. 3 illustrates, by way of example, a diagram of a system for generating a mix of character voices using the trained voice model.

FIG. 4 illustrates, by way of example, a diagram of an embodiment of a system for inferring a voice.

FIG. 5 illustrates, by way of example, a diagram of an embodiment of a method for voice inference in a video game.

FIG. 6 is a block diagram of an example of an environment including a system for neural network (NN) training.

FIG. 7 is a block schematic diagram of a computer system for performing methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized, and that structural, logical and electrical changes may be made without departing from the scope of the present invention. The following description of example embodiments is, therefore, not to be taken in a limited sense, and the scope of the present invention is defined by the appended claims.

A real-time or near real-time synthesized voice would help users suspend disbelief. Further, the real-time or near real-time synthesized voice would help preserve anonymity and privacy of the user. Voice synthesis in a video game (e.g., a multiplayer video game) includes a player selecting character voices to be mixed. The characters can include characters from video games, movies, other players of the game, or other prerecorded voices. Then, when the player speaks into a microphone while playing the game as the character, or the character has a predefined speech in the game, the speech of the character is converted to the voice of the character before it is presented to other players. In short, when a player speaks to other players in the game or hears their voice playing the game, their voices get synthesized in the voice of the selected character mixture. In some embodiments, the voice of the player is inferred based on physical characteristics. The physical characteristics can be derived from an image or selected by the player.

Current online games are closed loop systems that do not, or rarely, interface with an external system like a voice box. Online games are live experiences, and it is not feasible for the players to stop playing to use the external system. Thus, many solutions to voice synthesis are not usable in the context of online video games.

Voice synthesis increases privacy and reduces the risk of bullying of the player. When playing online with voice chat, female players and children are more likely to be harassed than other players. Using voice synthesis, the characteristics of the human player are not shared to the other players and are not discernible by the synthesized voice. Voice synthesis thus helps prevent a source of the harassment.

Voice synthesis allows any player to have better immersion while playing online games. Voice synthesis thus increases the suspension of disbelief in playing of the game.

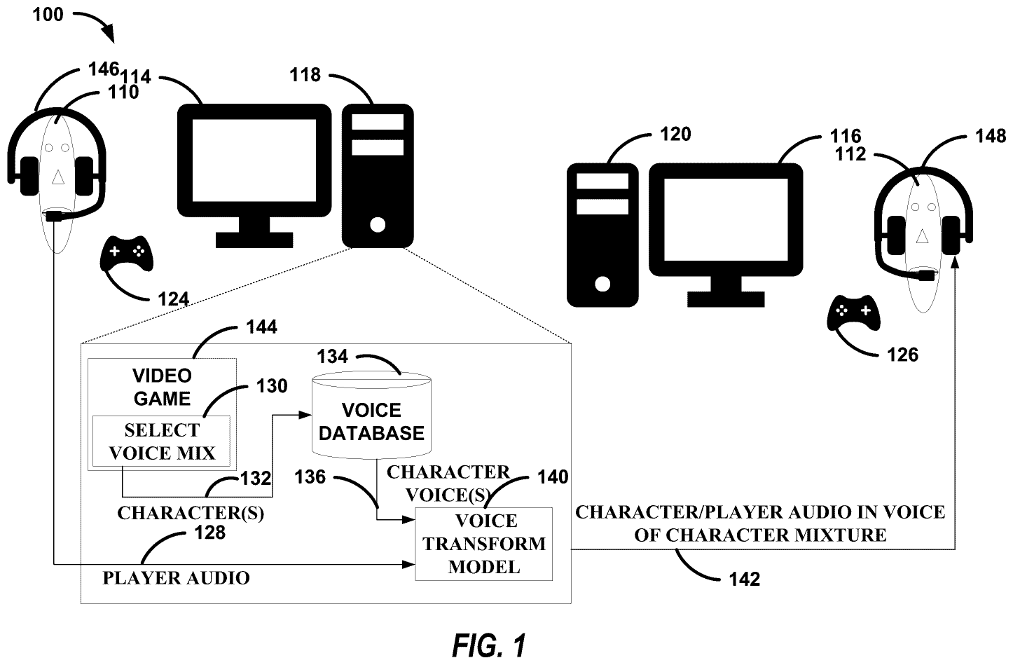

FIG. 1 illustrates, by way of example, a diagram of an embodiment of a system 100 for voice synthesis via voice mixing. The system 100 as illustrated includes players 110, 112 of a video game 144 that access the video game 144 through a compute device 118. The video game 144 can be hosted locally on one or more of the compute devices 118, 120. The video game 144 can be hosted remotely, such as in the cloud, and accessible through the internet. In some instances, a portion of the video game is hosted locally and a portion of the video game is hosted remotely.

The players 110, 112 often wear respective headsets 146, 148 that include speakers (e.g., over the ear speakers) and a microphone. The users 110, 112 often play the game using a controller 124, 126 that is communicatively coupled to the compute device 118. The users 110, 112 watch their progress and interact with other players in the game through respective displays 114, 116 communicatively coupled to the respective compute devices 118, 120.

The compute device 118, 120 can include any device capable of executing a video game. The compute device 118, 120 and display 114, 116 while illustrated as a desktop computer and a separate display device in separate packages, can alternatively include a handheld device, a laptop computer, an extended reality (XR) headset (e.g., a virtual reality (VR), augmented reality (AR) headset, or the like), that include components and a display in a single device package.

To perform voice synthesis, the compute devices 118, 120 can each use a voice transform model 140. The voice transform model 140 converts player audio 128 (or preprogrammed speeches of their selected character) into character audio in the voice of the character mixture 142. Using the voice transform model 140, the user 110 can speak to generate the player audio 128, but the player audio 128 is presented as the player audio in the voice of the character voice mixture 142 to players 112 of the video game.

The voice transform model 140 can include a neural network (NN). The voice transform model 140 can be trained in a supervised or semi-supervised manner to convert a spectrogram of the player audio 128 into a spectrogram consistent with a mixture of selected characters 132.

The voice transform model 140 can operate based on input that includes the player audio 128, character voices 136, or a combination thereof. The player audio 128 is the audio provided by the user 110.

The characters 132 are the avatars and corresponding characteristics of an entity that the player can use to represent themself in gameplay. A player, when launching a game or midgame, can be given a selection of characters to choose from by a select voice mix interface 130. The player often selects a character with a voice that they relate to, aspire to be, admire, or the like. The select voice mix interface 130 is presented as a graphical display through which the player 110 (sometimes called a “user”), using the controller 124 for example, can select character voices they wish to represent them in playing the game.

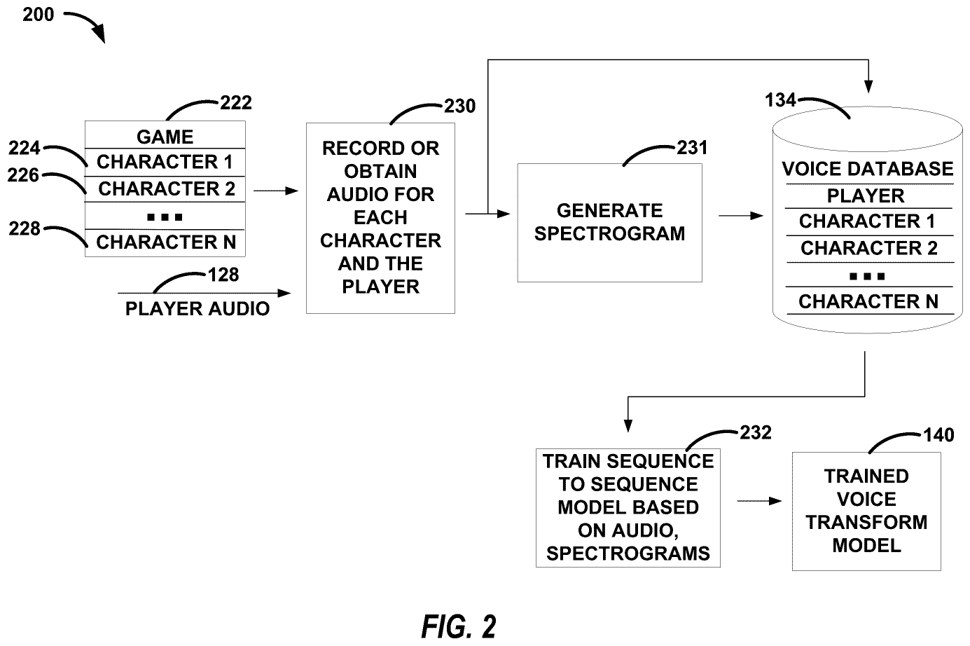

The character voices 136 are spectrograms, actual audio, other representation of a voice that can be used by the voice transform model 140 to synthesize a voice, or a combination thereof. The character voices 136 are illustrated as being stored in a voice database 134. The character voices 136 can be indexed in various ways, such as in alphabetical order by name, a combination of game of origin and alphabetical order, time the voice was added to the database 134, popularity (number of players that have used the voice as part of a voice mix), or a combination thereof. The character voices 136 can include a voice of the player 110, 112. More details regarding populating the voice database 134 are provided in FIG. 2.

FIG. 2 illustrates, by way of example a flow diagram of an embodiment of a method 200 for populating the voice database 134. The method 200 as illustrated includes identifying character voices 224, 226, 228 to be included in a potential voice mixture in a game 222. For each of the character voices 224, 226, 228 and the player 110, 112 audio can be recorded or obtained at operation 230. The operation 230 can include using voice actors, props, ML models, vocal effects processors, sound effects, or the like to generate the audio for each character voice 224, 226, 228.

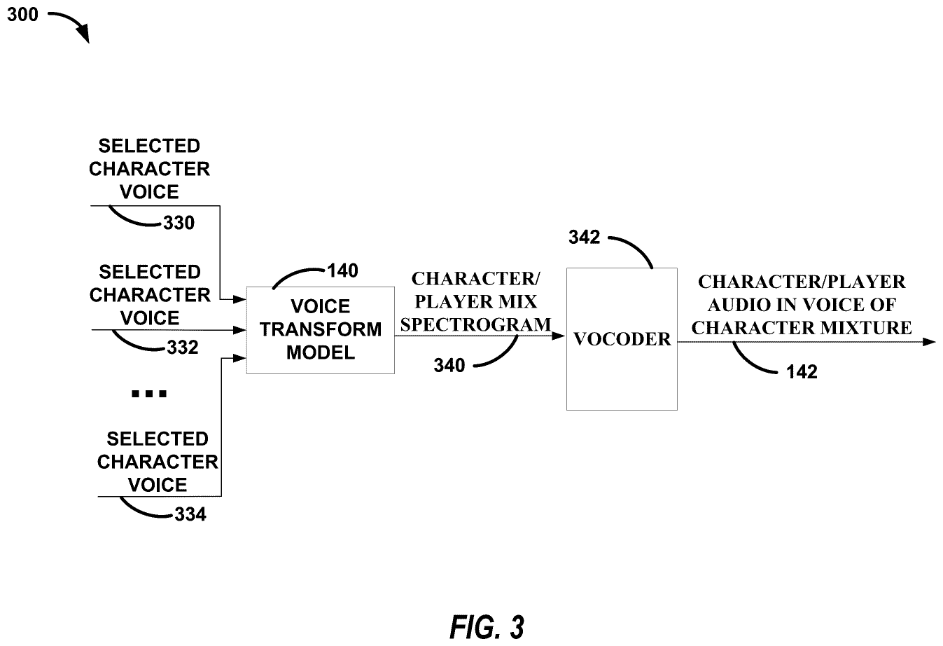

A spectrogram for each audio sample, from the operation 230, can be generated at operation 231. The operation 231 can include using a Fourier transform, such as a short-time Fourier transform (STFT), to generate a spectrogram. A spectrogram of player or character audio can be used, alone or in combination with, selected character voice data 330, 332, 334 as input to the voice transform model 140 as illustrated in FIG. 3. The spectrograms can be generated using an STFT. The spectrogram can be generated by dividing audio into short overlapping segments. Those segments can then be processed by a Fourier map or transform to provide the underlying frequency content and corresponding amplitudes. For each segment, we then have a Fourier transform. The Fourier transforms can be combined to produce a final spectrogram that is readable by the sequence-to-sequence model. Each point of the final spectrogram represents the intensity of a particular frequency at a certain time. The spectrogram can include datapoint triplets (e.g., <frequency, time, intensity>). Each triplet describes the frequency spectrum of the sound signal from the end-user over a time slice.

A sequence-to-sequence model can be trained at operation 232 and based on the recorded or obtained audio generated at operation 230, a spectrogram of the audio, or a combination thereof. A sequence-to-sequence model translates a first sequence into a second sequence. The sequence-to-sequence model can include one or more transformers that use self-attention, cross-attention, or a combination thereof. The sequence-to-sequence model can include an encoder with an attention mechanism, known as a context vector. The encoder processes the audio input and captures important information, which is stored as a hidden state. The context vector is a weighted sum of input hidden states and is generated for every time instance of the output sequence. The decoder takes the context vector and hidden states from the encoder and generates the final output sequence. In decoder operates in an autoregressive manner, producing one element of the output sequence at a time. The decoder considers previously generated elements, context vector, and input sequence information to generate the next element of the output sequence. In a model with attention, the context vector and the hidden state are concatenated to form an attention hidden vector. A result of the training operation 232 is a trained voice transform model 140.

The trained voice transform model 140 operates on the player audio 128, spectrogram of the player audio 128, preprogrammed speech of a character, spectrogram of the preprogrammed speech of the character, or a combination thereof, to generate player audio in the voice of the character mixture 142. The trained voice character model 140 operates without translating the input audio to an intermediate text representation. The intermediate text representation is often used to translate input audio into another language. Using the intermediate text representation, a user provides audio, which is converted to an intermediate text representation and then decoded to another language. Using the trained voice character model 140, in contrast, a spectrogram of the player audio 128 is converted directly to a spectrogram of the player audio in the voice of the character mixture 142. Directly, in this context, means that the model 140 does not generate the intermediate text representation.

The intermediate text representation is cost and time prohibitive and is not required for converting the player audio 128 into audio in the voice of the character mixture 142. The intermediate text representation is not needed, at least in part, because translation is not the goal. The goal of the trained voice transform model 140 is instead to convert waveform patterns of the player audio 128 into waveform patterns consistent with the waveform patterns of the selected characters 132.

The player 110, 112 can record themselves at operation 230. The audio recording, a spectrogram of the audio recording, or a combination thereof, can be combined with other audio or spectrograms of the audio by the trained voice transform model 140. The voice of in-game characters from the voice database 134, D={v1f, . . . , vnf} can be leveraged online during gameplay to combine the player audio 128 with characteristics of character voices. More formally, the trained voice transform model 140 performs operations of Mix(character 1, character 2, . . . ,character n)=spectrogram of mix of player/character audio. The trained voice model 140 can be used, by a player 110, 112 to hear how characters of the game would speak if they were a unique new character.

A single attentive sequence-to-sequence model without intermediate text representation is trained. A source spectrogram from the player audio 128 is generated and provided as input to the model along with the selected character. The model is trained to generate spectrograms of the mixes of selected character audio.

During training, the sequence-to-sequence model uses a multitask objective to predict source and target transcripts while also generating target spectrograms. However, no transcripts or other intermediate text representations are generated by the model or used by the model during inference. Training the model can be accomplished using a set of pre-recorded input voices from a wide variety of individuals and the mapped target voices generated or obtained at operation 230 of the in-game characters. The training can be accomplished within in-domain data. In-domain data takes into consideration the uniqueness of an in-game vocabulary. In-domain data is contrasted with universal vocabulary, which is realized by a model trained by a wider variety of contexts. Examples of wider contexts include Wikipedia or Reddit data that are not constrained to a single game environment. Some words, and corresponding tokens, to be spoken by the character 132 can be more prevalent in the context of the game than in the universal context. Further, the pronunciation of some of these words may be unique to the game context and can be important to providing a user with an optimally immersive gaming experience. The pronunciation in the context of the game might be better understood with an example. A game may include a town with the name “Nevada”. In a more universal context, the word “Nevada” can be a heteronym for the same word in the game context. For example, in the universal context, it can be understood that “Nevada” is pronounced as “Ne-vad-uh” while, in the game context, “Nevada” is pronounced as “Ne-vay-duh”. It is thus important to have the trained character voice model 140 trained based on in-domain pronunciations of the words.

The trained voice model 140 can further include one or more other separately trained components, such as a neural vocoder 342 (see FIG. 3) that converts output spectrograms to time-domain waveforms.

FIG. 3 illustrates, by way of example, a diagram of a system 300 for generating a mix of character voice 142 using the trained voice model 140. The trained voice model 140 as illustrated is coupled to a neural vocoder 342. The voice transform model 140 generates a spectrogram 340 of the mix of character voices. The vocoder 342 converts the spectrogram 340 in the player audio in the voice of the character voice mixture 142.

The trained character voice transform model 140 can receive audio of selected character voices 330, 332, 334 or spectrograms of the selected character voices 330, 332, 334. The character voices 330, 332, 334 can include audio of the player 110, 112, spectrogram of audio of the player 110, 112, or a combination thereof. The trained character voice transform model 140 generates a character spectrogram 340. The spectrogram 340 indicates a time series of characteristics of the mix of character audio. The character spectrogram 340 can detail frequency and amplitude data for the audio in a series of timeframes. The timeframes of the spectrogram 340 can be consistent with frames of the video game. The character spectrogram 340 is the spectrograms of the selected character voices 330, 332, 334 altered to be consistent with the mix of audio characteristics of the selected character voices 330, 332, 334.

Video games can include a series of in-game frames that are converted to audio and video. With each frame, F, there is a lot of information that can include a non-exhaustive list of parameters, P. The parameters, P, are the state of the character, such as whether the character is bleeding, the character tiredness, the character emotional state (e.g., whether they are angry, happy, sad, etc.), whether the character is wearing a helmet, or the like. Those parameters are not trivially filtered out since they are encapsulated in an abstract coded object representing a frame and dynamically populated during the game. The character can thus be represented by an object class, character, with several parameters that are dynamically populated across the game. Those parameters can be filtered using a specific model focusing on those described objects available in the logs for example.

In many video games, the environmental effects on audio are managed by in-game audio rendering, such as audio raytracing for directional effects. For example, a system can receive a game log and is responsible for applying environmental effects to the voice, such as echo or reflection on metal. The trained voice transform model 140 operates independent of such an environmental effects system and does not alter operation of the environmental effects system.

In some instances, the players 110, 112 can communicate with each other outside of the game play. This is sometimes called “direct communication”. With direct communication, the trained character voice transform model 140 can be provided with a default character state. The trained voice transform model 140 can thus be used outside of the game context and allow a user to disguise their voice.

Using the trained voice model 140, the player 110, 112 can decide to play with a certain character and use a voice other than the default voice of the character. The voice can be selected from a displayed database of voices or from a recorded voice of choice. The generated voice can include aspects of the voice of the player 110, 112 or not.

If the player 110, 112 is a female or a child, for example, the voice generated by the trained voice model 140 can have typical male voice characteristics. Such configurations help preserve player 110, 112 privacy, reduce chances that the player 110, 112 is bullied, and increase the changes of the player 110, 112 being accepted as part of the game community.

Some players 110, 112 have disabilities that do not allow them to record a voice that can be used in the voice of the character voice mixture 142. Some players 110, 112 do not want to record their voice for pricy reasons. Some players 110, 112 otherwise do not want to generate a voice of character voice mixture 142 that includes their voice. For such players 110, 112 a voice can be inferred based on physical characteristics.

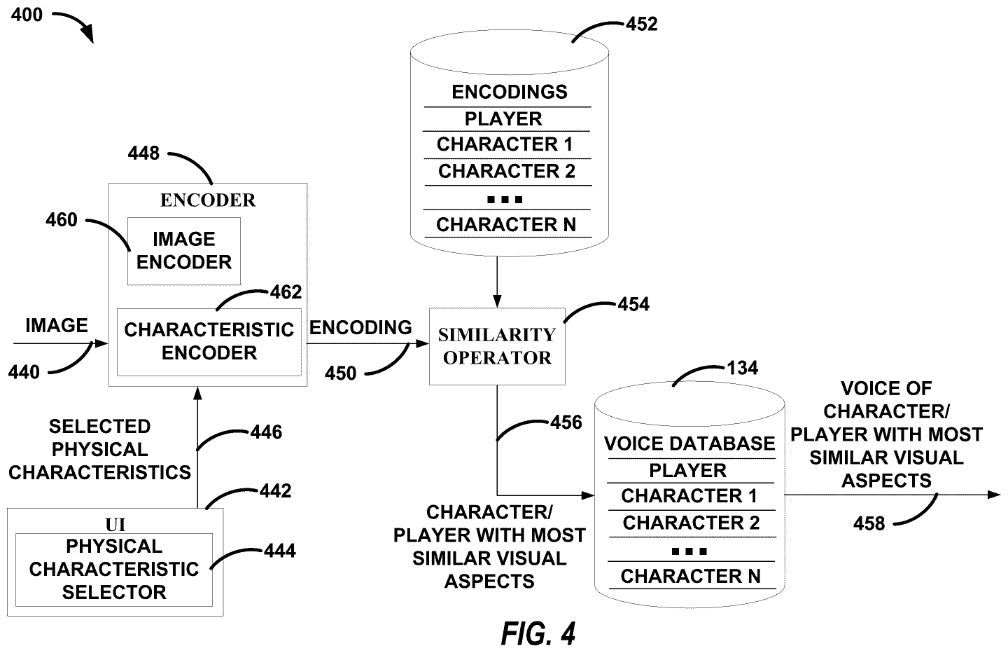

FIG. 4 illustrates, by way of example, a diagram of an embodiment of a system 400 for inferring a voice. The inferred voice can be used on its own or mixed with other voices, such as by using the voice transform model 140.

The system 400 as illustrated includes an encoder 448, a database of encodings 452, a similarity operator 454, and the voice database 134. The encoder 448 receives an image 440 of a character or player, selected physical characteristics 446, or a combination thereof. The image 440 can include a full body, partial body, portrait or other image of a desired physique. The image 440 can be provided by the player 110, 112 through an interface of the video game 144.

The selected physical characteristics 446 can be selected by the player 110, 112 through a physical characteristic selector 444 of a UI 442 of the video game 144. The selected physical characteristics 446 indicate desired physical aspects of a character for which to infer a voice. Examples of selected physical characteristics 446 include skin color, height, weight, facial characteristics, such as nose size, shape, or the like, eye size, color, shape, or the like, ear size and shape, eye brow color, size, shape, or the like, lip size, shape, color, or the like, cranium shape, size or the like, or hair style, length, color, or the like, muscle tone, arm length, torso length, leg length, hand size, or foot size, among others. The physical characteristic selector 444 can be presented as a software controls that allow the user to adjust the physical characteristics. The physical characteristic selector 444 can provide an image that includes an instance of the selected physical characteristics 446.

The encoder 448 can include an image encoder 460, a characteristic encoder 462, or a combination thereof. The encoders 460, 462 can include an NN, a heuristic model, or the like, that converts the image 440, the selected physical characteristics 446, or a combination thereof to an encoding 450.

The encoding 450 can include a feature vector that encodes the image 440, the physical characteristics in the image 440 or the selected physical characteristics 446, or a combination thereof. The encoding 450 can include a feature vector representation of just the physical characteristics of the entity in the image 440 or the selected physical characteristics 446 without an encoding of the image 440. In some instances, the encoding of the image 440 can be used for training. Then, during inference, the encoder 448 can provide just an encoding of the physical characteristics.

The image encoder 460 can include a convolutional NN (CNN). The image encoder 460 can generate an image encoding. The image encoding can encode a tensor representing the character in the image 440 into a fixed-sized vector representation. The CNN can include an attention-based CNN (e.g., ResNet with self-attention) or a more traditional CNN (e.g., ResNet). A tensor is an algebraic object that describes multilinear relationships between sets of algebraic objects related to a vector space.

The characteristic encoder 462 can encode physical characteristics of the character in the image 440 or the selected physical characteristics 446. The characteristic encoder 462 can include a one-hot encoder. The one-hot encoder can generate a one-hot encoding. The characteristic encoder 462 can be used to generate a vector representation. For discrete physical characteristics (e.g., eye color, skin color, hair color, gender, age, etc.), a one-hot encoding without normalization can be used. For continuous physical characteristics (e.g., height, weight, etc.) a one-hot encoding with normalization can be used. The characteristic encoder 462 can further include an auto-encoder. The auto-encoder can be used to compress a vector representation of the physical characteristics into a latent space of lower dimension. An auto-encoder is trained to copy its input to its output. In copying the input to the output, the auto-encoder encodes its input to a lower-dimensional latent representation. This lower-dimensional latent representation is thus a compressed vector representation of the input.

The encodings from the image encoder 460 and the characteristic encoder 462 can be combined to form a single vector representing <image, physical characteristics>. For example, if the selected physical characteristics 446 are provided without an image 440, the selected physical characteristics 446 can be used as the physical characteristic encoding. If only the image 440 is given without the selected physical characteristics 446, the image encoder 460 (which is more computationally expensive than the selected physical characteristics 446) can be used to generate the physical characteristic encoding 450. If both the image 440 and the selected physical characteristics 446 are provided, they can be averaged (e.g., by a weighted average) and used as the encoding 450. In some instances, one of the encodings, of the encodings from the image encoder 460 and the characteristic encoder 462, is more trustworthy. In such instances, the more trusted encoding can be used. For example, if image quality is low, the selected physical characteristics 446 can be used as the encoding 450.

To train the characteristic encoder 462, compressed vector representations of a wide range of physical characteristics can be used. To get the compressed vector representation for physical characteristics one-hot encoded characteristics and an autoencoder can be used. A mean squared error (MSE) loss function, for example, can be used to learn the compressed representation.

To train the image encoder 460, a dataset of <image, corresponding physical characteristics one-hot encoded>can be used. High quality images covering different angles, lighting, and other common conditions can be gathered. For each image, the image can be labelled into physical characteristics, such as by human annotation, a high-accuracy classifier model, or a combination thereof.

A triplet loss function is useful for learning an encoding and for eventually finding closest points. The triplet loss function can be used to train the image encoder 460. During training, select a triplet of samples: anchor (target image 440), a positive (image with similar characteristics, such as from the database 452 (e.g. similar skin color or other characteristic)) and a negative (an individual with dissimilar characteristics, such as from the database 452 (e.g., different skin color and gender, or other characteristic)). The anchor, positive, and negative samples can be passed through the image encoder 460 to obtain respective encodings. The triplet loss can then be computed to ensure a distance between similar images is closer than dissimilar ones. More simply a cross-entropy loss function can be used, but a triplet loss in this particular application helps to simplify the similarity operator 454 operation.

The similarity operator 454 can determine respective distances between the encoding 450 and encodings in an encodings database 452. The encodings in the database 452 can be generated using the same encoder, or similar encoder that retains the same dimensions as output of the encoder 448. The distance can be an angular distance, a cosine similarity, a Levenstein distance, a Hamming distance, or other distance in feature space. Feature space is a mathematical space that includes dimensions equal to a number of entries in the encodings of the encoding 450 and the encodings in the encoding database 452. The similarity operator 454 can generate the distance for each encoding in the database 452 and the encoding 450. The distance that is the smallest (or the metric that otherwise indicates the most similar encoding) can be identified, such as by the similarity operator 454. The character/player 456 associated with the encoding in the database 452 that corresponds to the smallest distance can be used to retrieve a voice from the voice database 134. The spectrogram, voice of the character/player 458 can be retrieved based on the character/player 456 indicated by the similarity operator 454.

Note that the similarity operator 454 can, instead of indicating a single, most similar character, can indicate multiple similar characters. The multiple similar characters can include a physical characteristic most similar to a physical characteristic of the entity in the image 440 or the selected physical characteristics 446. The voice of the character/player with most similar visual aspects 458 can thus include data indicating multiple characters/players. Multiple character voices (e.g., spectrograms of multiple character voices) can then be processed by the system 300 to generate audio in the voice of the character voice mixture 142.

The system 400 can be used to generate a voice for a character or player that has no predefined voice. The encoder model 448 can consider visual aspects of the character or player. The visual aspects (the encoding 450) can be used by the similarity operator 454 to infer an appropriate voice for the character or player.

A list of pairs for in-game characters across games {‘character visual image’: (e.g., a png/jpeg object), ‘character voice’: (e.g., an mp4 object)} can be stored between the encodings database 452 and the voice database 134. The similarity metric on the encodings of the visual representations of the new character can be determined, by the similarity operator 454, as compared with the existing characters. This is essentially a search engine leveraging similarity over the indexed images of existing characters where the query is the new character with no associated voice. The one or more voices (e.g., actual audio or spectrograms of audio) associated with the closest looking character(s) can then be retrieved.

Similarly, the system 400 can create a voice for the individual player leveraging either a picture of the player or their camera display. This aspect is in alignment with an inclusiveness approach as it can uniquely serve people with a disability who cannot speak. Such individuals can choose to mix their inferred voice with a stored voice from the voice database 134. For example, in “The Witcher”, a player could make their voice sound more like Geralt's voice whilst preserving the unique traits of their own voice by leveraging the voice transform model 140. The voice transform model 140 performs the operations of [symbol] model: [symbol] ( [symbol] (player), vs) Where [symbol] (player) returns the inferred voice from the player and vs is the stored voice value for the selected character s.

Additionally, the individual player can choose ethnicity, gender, etc., to make the inference more robust, and choose if they want their voice to come with an accent or not. Such parameters can either be inputted directly by the end-user through the physical characteristic selector interface 444 or inferred by the encoder model 448, [symbol] .

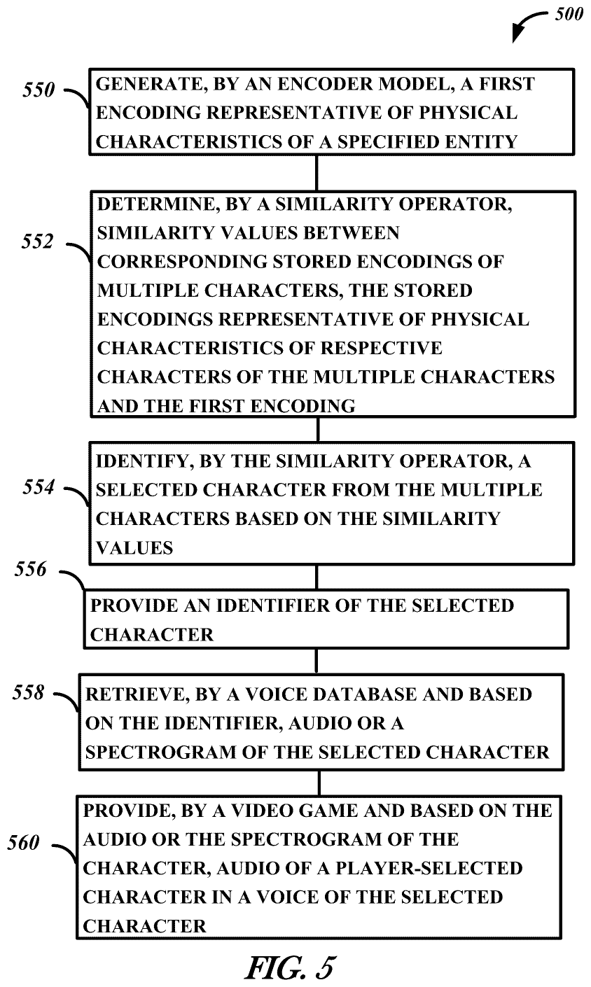

FIG. 5 illustrates, by way of example, a diagram of an embodiment of a method 500 for voice inference in a video game. The method 500 as illustrated includes generating, by an encoder model, a first encoding representative of physical characteristics of a specified entity, at operation 550; determining, by a similarity operator, similarity values between (i) corresponding stored encodings of multiple characters, the stored encodings representative of physical characteristics of respective characters of the multiple characters and (ii) the first encoding, at operation 552; identifying, by the similarity operator, a selected character from the multiple characters based on the similarity values, at operation 554; providing an identifier of the selected character, at operation 556; retrieving, by a voice database and based on the identifier, audio or a spectrogram of the selected character, at operation 558; and providing, by a video game and based on the audio or the spectrogram of the character, audio of a player-selected character in a voice of the selected character, at operation 560.

The entity can be a player of the video game. The method 500 can further include receiving, by the encoder model, an image of the player and wherein the encoder model generates the first encoding based on the image of the player. The method 500 can further include presenting, by a physical characteristic selection interface of the video game, physical characteristics. The method 500 can further include receiving, from the player, the physical characteristics of the entity.

The method 500 can further include receiving, by a voice transform model, spectrograms of multiple, player-selected characters. The method 500 can further include generating, by the voice transform model a composite spectrogram that is a mixture of the received spectrograms.

The received spectrograms can include a spectrogram of the selected character and the selected character is associated with physical characteristic most similar to the entity. The received spectrograms can include a spectrogram of audio from the player. The voice transform model can include a sequence-to-sequence model trained to convert the received spectrograms directly into the composite spectrogram.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The voice transform model 140, operator 231, encoder 448, similarity operator 454, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

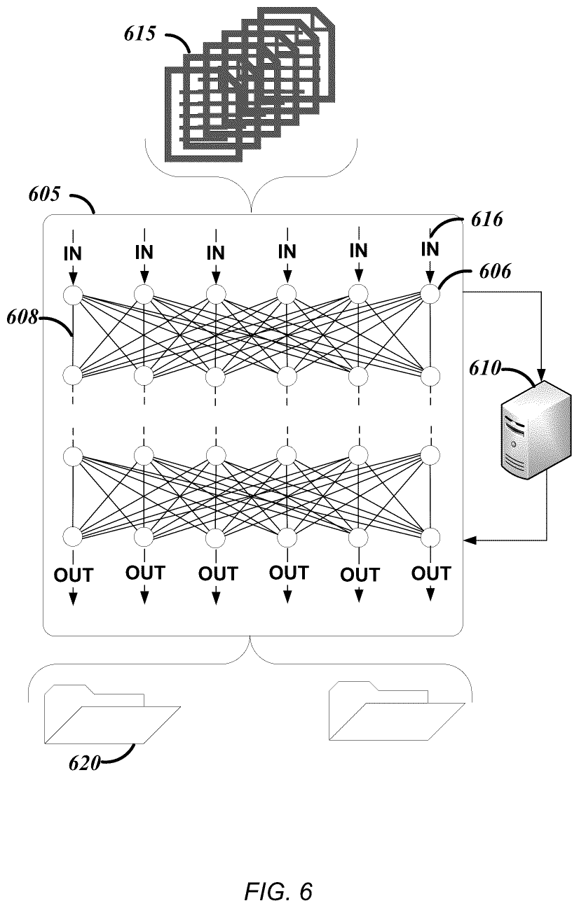

FIG. 6 is a block diagram of an example of an environment including a system for neural network (NN) training. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 606 within layers. Thus, a set of processing nodes is arranged to perform the training of the ANN 605. The voice transform model 140, operator 231, encoder 448, similarity operator 454, a combination thereof, or the like can be trained using the system.

The set of processing nodes is arranged to receive a training set 615 for the ANN 605. The ANN 605 comprises a set of nodes 606 arranged in layers (illustrated as rows of nodes 606) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 616 to be classified after ANN 605 is trained, is provided to a corresponding node 606 in the first layer or input layer of ANN 605. The values propagate through the layers and are changed by the objective function.

As noted, the set of processing nodes is arranged to train the neural network to create a trained neural network. After the ANN is trained, data input into the ANN will produce, for example, valid classifications 620, encodings, or other transformations (e.g., the input data 616 will be assigned into categories), for example. The training performed by the set of processing nodes 606 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 606 (e.g., neurons) are trained independently. In an example, the nodes are trained on different hardware.

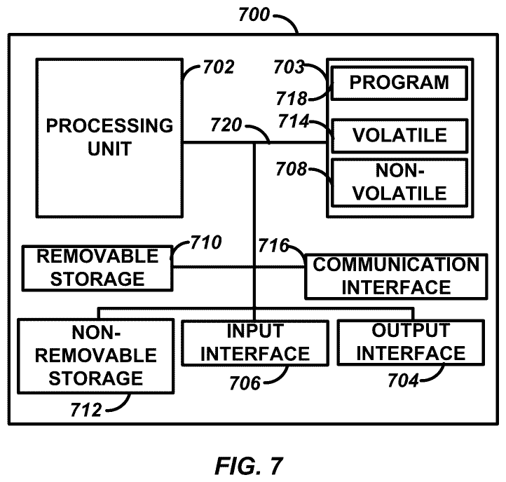

FIG. 7 is a block schematic diagram of a computer system 700 to perform voice inference, and for performing methods and algorithms according to example embodiments. Any of the components or operations of the video game 144, select voice mix interface 130, trained voice transform model 140, compute device 118, 120, controller 124, 126, headset 146, 148, operations 230, 231, 232, the vocoder 342, encoder 448, similarity operator 454, UI 442, physical characteristic selector 444, method 500, or other component or operation can be implemented using the system 700 or a component thereof. All components of the system 700 need not be used in various embodiments.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 718 may be used to cause processing unit 702 to perform one or more methods or algorithms described herein.

### Examples and Additional Notes

Example 1 includes a video game system comprising an encoder configured to generate a first encoding representative of physical characteristics of a specified entity, a similarity operator configured to determine similarity values between (i) corresponding stored encodings of multiple characters, the stored encodings representative of physical characteristics of respective characters of the multiple characters and (ii) the first encoding, identify a selected character from the multiple characters based on the similarity values, and provide an identifier of the selected character, a voice database configured to provide audio or a spectrogram of the selected character, and a video game configured to provide the audio of a player-selected character in a voice of the selected character.

In Example 2, Example 1 further includes, wherein the physical characteristics represent physical attributes of respective characters in the video game and the entity is a player of the video game.

In Example 3, Example 2 further includes, wherein the encoder generates the first encoding based on an image of the player.

In Example 4, at least one of Examples 2-3, further includes a physical characteristic selection interface of the video game configured to present physical characteristics to the player and receive, from the player, the physical characteristics of the entity.

In Example 5, at least one of Examples 2-4 further includes a voice transform model trained to receive spectrograms of multiple, player-selected characters and generate a composite spectrogram that is a mixture of the received spectrograms.

In Example 6, Example 5 further includes, wherein the received spectrograms include a spectrogram of the selected character and the selected character is associated with physical characteristic most similar to the entity.

In Example 7, at least one of Examples 5-6 further includes, wherein the received spectrograms include a spectrogram of audio from the player.

In Example 8, at least one of Examples 5-7 further includes, wherein the voice transform model includes a sequence-to-sequence model is trained to convert the received spectrograms directly into the composite spectrogram.

Example 9 includes a method including generating, by an encoder model, a first encoding representative of physical characteristics of a specified entity, determining, by a similarity operator, similarity values between corresponding stored encodings of multiple characters, the stored encodings representative of physical characteristics of respective characters of the multiple characters and (ii) the first encoding, identifying, by the similarity operator, a selected character from the multiple characters based on the similarity values, providing an identifier of the selected character, retrieving, by a voice database and based on the identifier, audio or a spectrogram of the selected character, and providing, by a video game and based on the audio or the spectrogram of the character, audio of a player-selected character in a voice of the selected character.

In Example 10, Example 9 further includes, wherein the entity is a player of the video game.

In Example 11, Example 10 further includes receiving, by the encoder model, an image of the player and wherein the encoder model generates the first encoding based on the image of the player.

In Example 12, at least one of Examples 10-11 further includes presenting, by a physical characteristic selection interface of the video game, physical characteristics, and receiving, from the player, the physical characteristics of the entity.

In Example 13, at least one of Examples 10-12 further includes receiving, by a voice transform model, spectrograms of multiple, player-selected characters, and generating, by the voice transform model a composite spectrogram that is a mixture of the received spectrograms.

In Example 14, Example 13 further includes, wherein the received spectrograms include a spectrogram of the selected character and the selected character is associated with physical characteristic most similar to the entity.

In Example 15, Example 14 further includes, wherein the received spectrograms include a spectrogram of audio from the player.

In Example 16, at least one of Examples 13-15 further includes, wherein the voice transform model includes a sequence-to-sequence model trained to convert the received spectrograms directly into the composite spectrogram.

Example 17 includes a non-transitory machine-readable medium including instructions that, when executed by a machine, cause the machine to perform operations for voice inference in a video game, the operations comprising receiving, from an encoder model, a first encoding representative of physical characteristics of a player of the video game, determining similarity values between (i) corresponding stored encodings of multiple characters, the stored encodings representative of physical characteristics of respective characters of the multiple characters and (ii) the first encoding, identifying a selected character of the multiple characters, based on the similarity values, corresponding to a character with character physical characteristics that are most similar to physical characteristics of the player, providing an identifier of the selected character, retrieving, by a voice database, audio or a spectrogram of the selected character, and providing, by the video game and based on the audio or the spectrogram of the character, audio of a player-selected character in a voice of the selected character.

In Example 18, Example 17 further includes, wherein the operations further comprise presenting, by a physical characteristic selection interface of the video game, physical characteristics, and receiving, from the player and by the physical characteristic selection interface, the physical characteristics of the player.

In Example 19, Example 18 further includes, wherein the operations further comprise receiving, by a voice transform model, spectrograms of multiple, player-selected characters including a spectrogram of the selected character, the selected character associated with physical characteristics most similar to the physical characteristics of the player, and generating, by the voice transform model, a composite spectrogram that is a mixture of the received spectrograms.

In Example 20, Example 19 further includes, wherein the voice transform model includes a sequence-to-sequence model trained to convert the received spectrograms directly into the composite spectrogram.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine. Thus, a module can include software, hardware that executes the software or is configured to implement a function without software, firmware, or a combination thereof.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A video game system comprising:
an encoder configured to generate a first encoding representative of physical characteristics of a specified entity;
a similarity operator configured to:
determine similarity values between (i) corresponding stored encodings of multiple characters, the stored encodings representative of physical characteristics of respective characters of the multiple characters and (ii) the first encoding;
identify a selected character from the multiple characters based on the similarity values; and
provide an identifier of the selected character;
a voice database configured to provide audio or a spectrogram of the selected character; and
a video game configured to provide the audio of a player-selected character in a voice of the selected character.

2. The video game system of claim 1, wherein the physical characteristics represent physical attributes of respective characters in the video game and the entity is a player of the video game.

3. The video game system of claim 2, wherein the encoder generates the first encoding based on an image of the player.

4. The video game system of claim 2, further comprising:
a physical characteristic selection interface of the video game configured to present physical characteristics to the player and receive, from the player, the physical characteristics of the entity.

5. The video game system of claim 2, further comprising:
a voice transform model trained to receive spectrograms of multiple, player-selected characters and generate a composite spectrogram that is a mixture of the received spectrograms.

6. The video game system of claim 5, wherein the received spectrograms include a spectrogram of the selected character and the selected character is associated with physical characteristic most similar to the entity.

7. The video game system of claim 5, wherein the received spectrograms include a spectrogram of audio from the player.

8. The video game system of claim 5, wherein the voice transform model includes a sequence-to-sequence model is trained to convert the received spectrograms directly into the composite spectrogram.

9. A method comprising:
generating, by an encoder model, a first encoding representative of physical characteristics of a specified entity;
determining, by a similarity operator, similarity values between (i) corresponding stored encodings of multiple characters, the stored encodings representative of physical characteristics of respective characters of the multiple characters and (ii) the first encoding;
identifying, by the similarity operator, a selected character from the multiple characters based on the similarity values;
providing an identifier of the selected character;
retrieving, by a voice database and based on the identifier, audio or a spectrogram of the selected character; and
providing, by a video game and based on the audio or the spectrogram of the character, audio of a player-selected character in a voice of the selected character.

10. The method of claim 9, wherein the entity is a player of the video game.

11. The method of claim 10, further comprising:
receiving, by the encoder model, an image of the player and wherein the encoder model generates the first encoding based on the image of the player.

12. The method of claim 10, further comprising:
presenting, by a physical characteristic selection interface of the video game, physical characteristics; and
receiving, from the player, the physical characteristics of the entity.

13. The method of claim 10, further comprising:
receiving, by a voice transform model, spectrograms of multiple, player-selected characters; and
generating, by the voice transform model a composite spectrogram that is a mixture of the received spectrograms.

14. The method of claim 13, wherein the received spectrograms include a spectrogram of the selected character and the selected character is associated with physical characteristic most similar to the entity.

15. The method of claim 14, wherein the received spectrograms include a spectrogram of audio from the player.

16. The method of claim 13, wherein the voice transform model includes a sequence-to-sequence model trained to convert the received spectrograms directly into the composite spectrogram.

17. A non-transitory machine-readable medium including instructions that, when executed by a machine, cause the machine to perform operations for voice inference in a video game, the operations comprising:
receiving, from an encoder model, a first encoding representative of physical characteristics of a player of the video game;
determining similarity values between (i) corresponding stored encodings of multiple characters, the stored encodings representative of physical characteristics of respective characters of the multiple characters and (ii) the first encoding;
identifying a selected character of the multiple characters, based on the similarity values, corresponding to a character with character physical characteristics that are most similar to physical characteristics of the player;
providing an identifier of the selected character;
retrieving, by a voice database, audio or a spectrogram of the selected character; and
providing, by the video game and based on the audio or the spectrogram of the character, audio of a player-selected character in a voice of the selected character.

18. The non-transitory machine-readable medium of claim 17, wherein the operations further comprise:
presenting, by a physical characteristic selection interface of the video game, physical characteristics; and
receiving, from the player and by the physical characteristic selection interface, the physical characteristics of the player.

19. The non-transitory machine-readable medium of claim 17, wherein the operations further comprise:
receiving, by a voice transform model, spectrograms of multiple, player-selected characters including a spectrogram of the selected character, the selected character associated with physical characteristics most similar to the physical characteristics of the player; and
generating, by the voice transform model, a composite spectrogram that is a mixture of the received spectrograms.

20. The non-transitory machine-readable medium of claim 19, wherein the voice transform model includes a sequence-to-sequence model trained to convert the received spectrograms directly into the composite spectrogram.
